(19) United States
(12) Patent Application Publication
(10) Pub. No.: US 2006/0130334 A1
(43) Pub. Date: Jun. 22, 2006

(54) Cutting device for trimming hair

(75) Inventor: Hye-San Park, Mie-Gun (JP)

Correspondence Address: ST. ONGE STEWARD JOHNSTON & REENS, LLC, 986 BEDFORD STREET, STAMFORD, CT, 06905-5619, US

(73) Assignee: Hye-San Park and Kanematsu Industrial Co., Ltd.

(21) Appl. No.: 11/111,169

(22) Filed: Apr. 21, 2005

(30) Foreign Application Priority Data
Dec. 17, 2004 (KR) 10-2004-0108278

(51) Int. Cl. B26B 21/12

(52) U.S. Cl. 30/30

(57) ABSTRACT

Disclosed herein is a cutting device for trimming hair, which can cut hairs regularly while adjusting the hairs in uniform thickness and slant when a user trims a client's hair in a beauty shop or house. The hair cutting device includes: a grip part, a fixing member, a plurality of cutter panels and a handle part. The cutting device allows anybody to effectively and easily cut the client's hair with a beautiful cut line, and can be widely applied in various ways according to wanted hair styles since it is simple in its structure and inexpensive.

This application claims priority of Korean Patent Application No. 10-2004-0108278 filed on Dec. 17, 2004.

### FIELD OF THE INVENTION

The present invention relates to a cutting device for trimming hair, which can cut a client's hairs regularly while adjusting the hairs in uniform thickness and slant when a user trims the hairs in a beauty shop or at general home.

### BACKGROUND OF THE INVENTION

In the cutting device for trimming hair according to the present invention, cutters (thin blades of a razor blade type) are buried into cutter panels of a comb-teeth type by an insert molding process, and then, the cutter panels are arranged in a tiered type and fixed on a fixing member to which a grip is combined. The cutting device having the above structure allows a user to cut a client's hair conveniently along the wave of hair as if the user combs hairs. The present invention has several advantages in that it has a simple structure and a simple using method, and in that even non-skilled person can easily cut the client's hair.

In general, there has been widely used hairdressing scissors having a cutting blade of a comb-teeth shape as a device for cutting hairs in uniform length or thickness. The conventional hairdressing scissors are to trim hairs in a uniform thickness. So, in the conventional hairdressing scissors, since it is difficult to perform a finishing cutting for trimming the hairs regularly, the user suffers from an inconvenience of additionally trimming and adjusting the client's hair with flat scissors regularly.

In particular, in case of woman's thick hairs, it takes too long time to cut and adjust the client's hair and a very skilled hair dresser is needed, since the thick hairs need long-term finishing-cutting work using the flat scissors to provide a beautiful cut line of the outer surface of the hairs after cutting.

### SUMMARY OF THE INVENTION

Accordingly, the present invention has been made in view of the above problems occurring in the prior art, and it is an object of the present invention to provide a cutting device for trimming hair, in which cutter panels of a comb-teeth type are arranged in a tiered type in order to allow a user to easily cut and adjust a client's hair in uniform thickness and length as if the user combs the client's hair.

To accomplish the above object, according to the present invention, there is provided a cutting device for trimming hair, including a grip part having a neck portion narrowly formed at an upper portion thereof for allowing a user to easily grasp the grip part with his or her hand, a protruding end portion pointedly formed at a lower end portion for allowing the user to part a client's hair in a wanted position using the protruding end portion, and an insertion chamber formed in an upper end portion thereof; a fixing member coupled to the upper end portion of the grip part, the fixing member having a coupling protrusion formed at a lower end portion thereof so as to be inserted into the insertion chamber of the grip part; a plurality of cutter panels mounted to the fixing member in such a manner as to be inclinedly arranged in parallel with one another at regular intervals on the fixing member, each of the cutter panels having a plurality of comb-tooth portions and indented portions which are alternately arranged at regular intervals, and a cutter integrally buried inside the comb-tooth portions; and a handle part having a tightening bolt protrudingly formed at one side thereof so as to be horizontally screwed to one side of the upper end portion of the grip part, whereby the fixing member is fixedly coupled to the grip part by the handle part in a state where the coupling protrusion of the fixing member is inserted into the insertion chamber of the grip part.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view according to a preferred embodiment of the present invention;

FIG. 2 is an exploded perspective view of the present invention;

FIG. 3 is a front view of the present invention;

FIG. 4 is a view showing a state where a user grasps the present invention with his or her hand;

FIG. 5 is a side view showing a mounted state of cutter panels according to the present invention;

FIG. 6 is a sectional view of the cutter panels of the present invention; and

FIG. 7 is a view showing a used state of the present invention.

### DETAILED DESCRIPTION OF THE DRAWINGS

Reference will now be made in detail to the preferred embodiments of the present invention, examples of which are illustrated in the accompanying drawings.

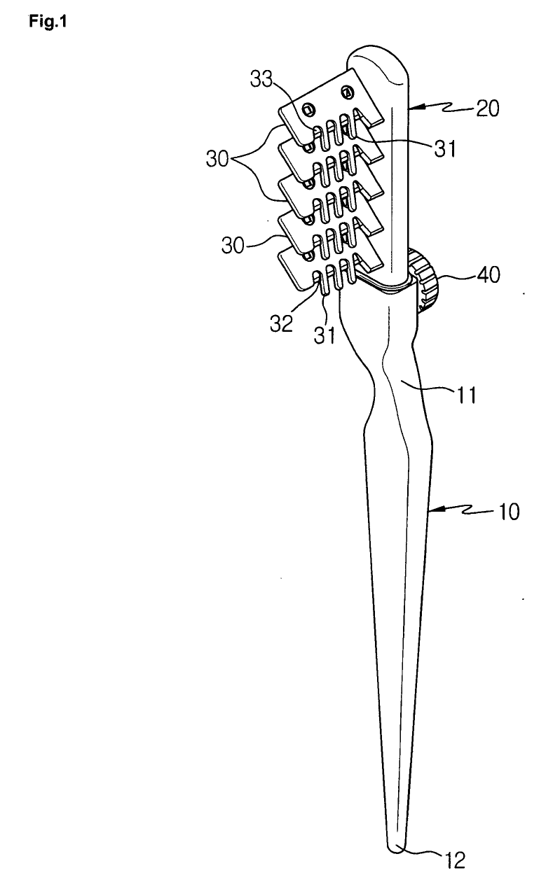

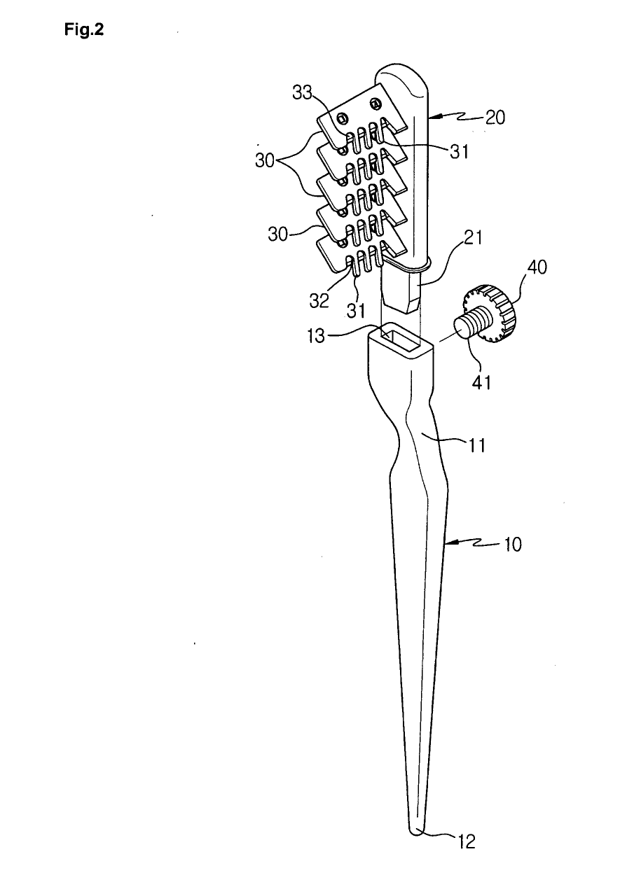

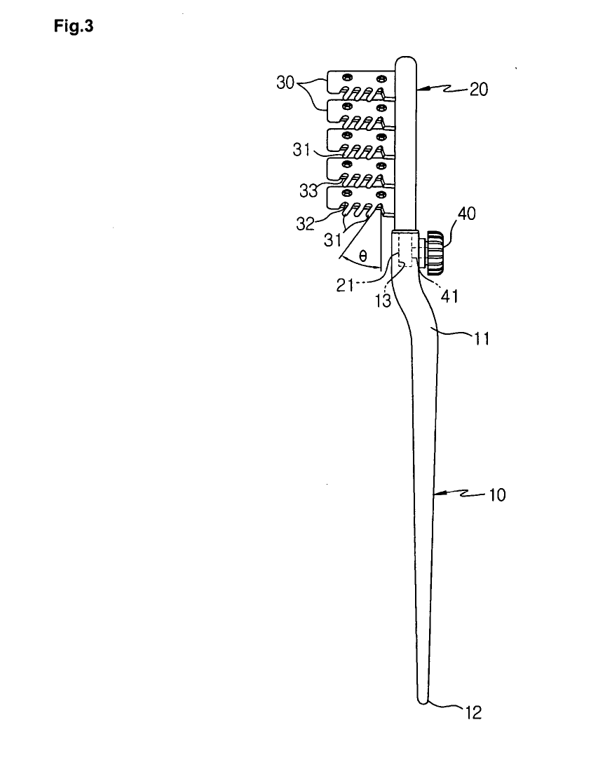

FIG. 1 is a perspective view according to a preferred embodiment of the present invention, and FIG. 2 is an exploded perspective view of a grip part and a cutting part of the present invention.

Referring to FIG. 1, there is shown a cutting device for trimming hair according to the present invention including a grip part 10, a fixing member 20, a number of cutter panels 30, and a hand part 40.

The grip part 10 includes a neck portion 11 narrowly formed at an upper portion thereof for allowing a user to easily grasp the grip part 10 with his or her hand, a protruding end portion 12 pointedly formed at a lower end thereof for allowing the user to part a client's hair in a wanted position using the protruding end portion 12, and an insertion chamber 13 formed in an upper end portion of the grip part 10.

The fixing member 20 is coupled to the upper end portion of the grip part 10. The fixing member has a coupling protrusion 21 formed at a lower end portion thereof so as to be inserted into the insertion chamber 13 of the grip part 10.

The plurality of cutter panels 30 are mounted to the fixing member 20 in such a manner as to be inclinedly arranged in parallel with one another at regular intervals on the fixing member.

The handle part 40 has a tightening bolt 41 protrudingly formed at one side thereof so as to be horizontally screwed to one side of the upper end portion of the grip part 10.

The fixing member 20 is fixedly coupled to the grip part 10 by means of the handle part 40 in a state where the coupling protrusion 21 of the fixing member 20 is inserted into the insertion chamber 13 of the grip part 10. The tightening bolt 41 of the handle part 40 can assemble or disassemble the fixing member 20 to or from the grip part 10.

Each of the cutter panels 30 has a plurality of comb-tooth portions 31 and indented portions 32 which are alternately arranged at regular intervals.

Each cutter panel 30 also has a cutter 33 integrally buried inside the comb-tooth portions 31 in a predetermined depth (W2) by an insert molding process.

Meanwhile, the cutter panels 30 are mounted on the fixing member 20 in such a way as to be inclined at the predetermined angle (θ: about 45° or less) with respect to the longitudinal direction of the fixing member 20, and arranged in a tiered type so as to maintain intervals (W) of about 5 mm between the cutter panels 30.

It is preferable that five cutter panels 30 are mounted on the fixing member 20, but if necessary, the fixing member 20 may have three, four, six or seven cutter panels 30 thereon, and selectively assembled to the grip part 10 using the tightening bolt 41.

To mount the cutter panels 30 on the fixing member 20, it is preferable that an end of each cutter panel 30 is combined to a molding cast of the fixing member 20 and insert-molded with the fixing member 20.

It is preferable that the interval between the indented portions 32 located between the comb-tooth portions 31 which are formed in a concavo-convex type is about 3 mm.

The operation and effect of the present invention having the above structure will be described as follows.

The cutting device for trimming hair according to the present invention is designed to inclinedly cut end portions of hairs by combing the hairs along the wave of the hairs.

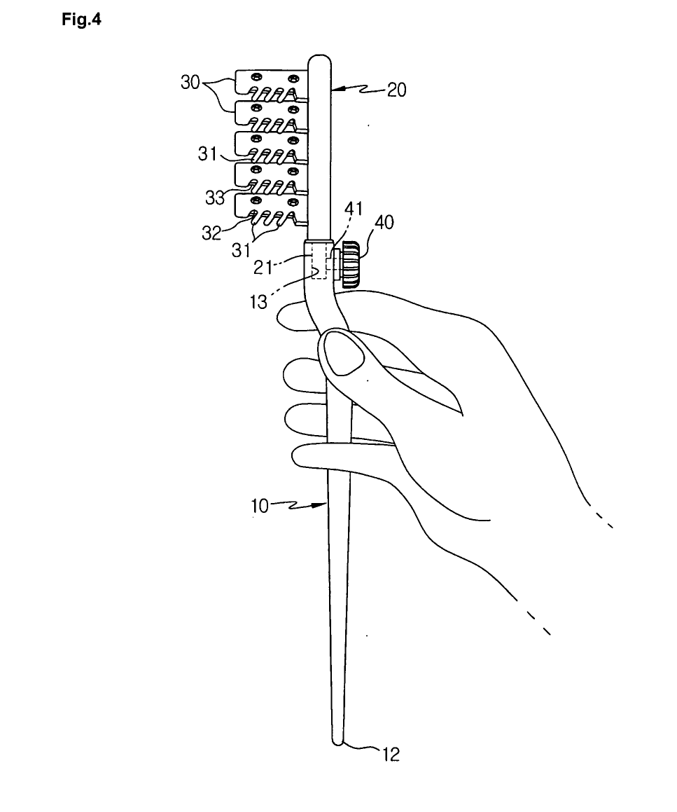

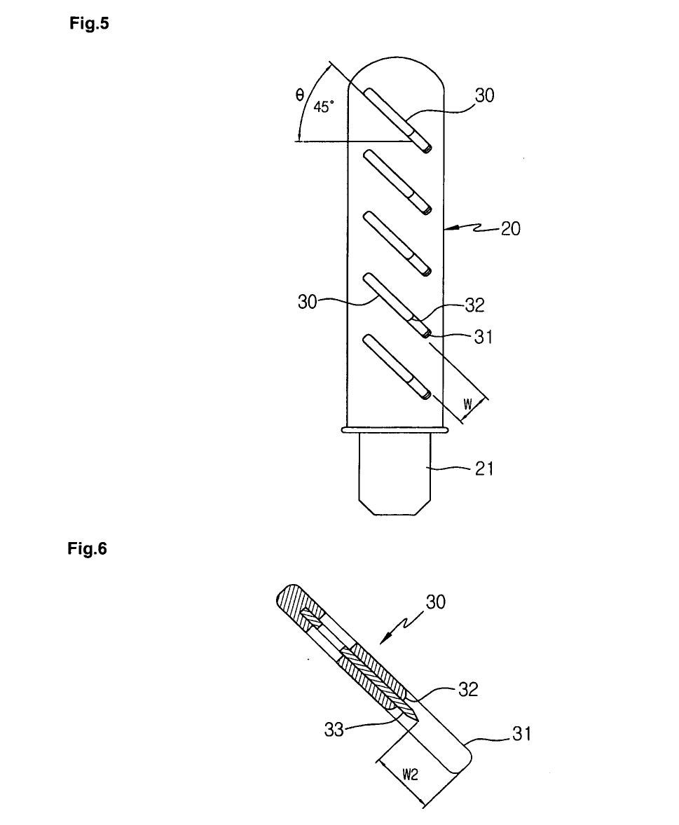

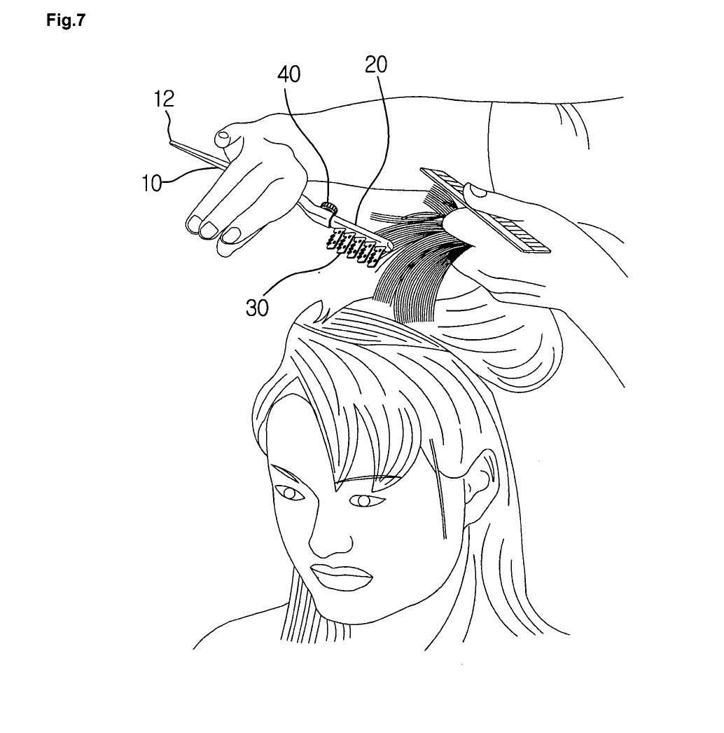

FIG. 4 shows a state where the user grasps the cutting device of the present invention with his or her hand.

That is, the user grasps the neck portion 11 of the grip part 10 with the thumb and the index fingers of his or her right hand in such a manner as to locate the index finger, the middle finger and the ring finger outwardly from the grip part 10, and the thumb and the little finger inwardly from the grip part 10 for grasping the cutting device in safe. After that, the user guides the hairs toward the indented portions 32, which are formed between the comb tooth portions 31 of the cutter panels 30, with his or her left hand, and then, cuts the client's hair as if the user combs the client's hair.

At this time, since the cutter panels 30 are fixed on the fixing member 20 at the predetermined inclination angle (45°) and arranged at regular intervals (W) in the tiered type, the hairs guided into the indented portions 32 of the cutter panels 30 are regularly cut along the inclined line by the cutter 33.

At this time, in order to cut the hairs guided into the cutter panels 30, the cutting device must be moved downwardly at a proper speed, that is, rapidly along the wave of the hairs while the hairs are guided into the indented portions 32 between the comb tooth portions 31. The cutting speed can be adjusted properly according to the volume of the client's hair or a wanted hair style.

Since the comb-tooth portions 31 are outwardly inclined at the predetermined angle (θ), the hairs located into the indented portions 32 of the cutter panels 30 are regularly cut by the cutters 33 respectively mounted inside the cutter panels 30 while the hairs are naturally guided and slid in the outward direction.

Differently from a cutting method using the conventional flat scissors and saw-toothed scissors, the present invention can regularly cut the hairs at the predetermined inclination angle along the inclined line of the cutting device by only once cutting action, and hence, the user can cut the client's hair more effectively and easily than the conventional hair cutting and trimming method that a hairdresser of a hair shop cuts and trims the client's hair.

Furthermore, the user can part the client's hair in a wanted position using the protruding end portion 12 of the grip part 10. In addition, if it is necessary to replace the cutter panel 30 with a different type cutter panel 30 or with a new one due to a damage of the cutter panel 30, the user can replace the cutter panel 30 with the new one or the different type cutter panel 30 by relieving the tightening bolt 41 using the handle part 40 and disassembling the fixing member 20 from the insertion chamber 13.

As described above, the cutting device for trimming hair according to the present invention can simultaneously cut and adjust the client's hair along the inclined line of the cutter panels while the hairs are guided through the indented portions and the comb-tooth portions of the cutter panels arranged in the tiered type at regular intervals and having the plural comb-toothed cutters. According to the present invention, even a non-skilled person can effectively and easily cut the client's hair with a beautiful cut line. In addition, the present invention is simple in its structure and inexpensive, and can be widely applied in various ways according to wanted hair styles.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A cutting device for trimming hair comprising:
a grip part having a neck portion narrowly formed at an upper portion thereof for allowing a user to easily grasp the grip part with his or her hand, a protruding end portion pointedly formed at a lower end portion for allowing the user to part a client's hair in a wanted position using the protruding end portion, and an insertion chamber formed in an upper end portion thereof;
a fixing member coupled to the upper end portion of the grip part, the fixing member having a coupling protrusion formed at a lower end portion thereof so as to be inserted into the insertion chamber of the grip part;
a plurality of cutter panels mounted to the fixing member in such a manner as to be inclinedly arranged in parallel with one another at regular intervals on the fixing member, each of the cutter panels having a plurality of comb-tooth portions and indented portions which are alternately arranged at regular intervals, and a cutter integrally buried inside the comb-tooth portions; and
a handle part having a tightening bolt protrudingly formed at one side thereof so as to be horizontally screwed to one side of the upper end portion of the grip part,
whereby the fixing member is fixedly coupled to the grip part by the handle part in a state where the coupling protrusion of the fixing member is inserted into the insertion chamber of the grip part.

2. A cutting device for trimming hair according to claim 1, wherein the cutter panels are arranged on the fixing member in a tiered type at an inclination angle of about 45° and at regular intervals (W).

3. A cutting device for trimming hair according to claim 1, wherein the comb-tooth portions are outwardly inclined at a predetermined angle (θ) with respect to the longitudinal direction of the fixing member.
